(19) United States
(12) Patent Application Publication
(10) Pub. No.: US 2016/0042671 A1
(43) Pub. Date: Feb. 11, 2016

(54) Social Media Device and method of providing social expression message

(71) Applicant: Name That Sticks, LLC, Peoria, AZ (US)

(72) Inventor: Ryan Allan Johnson, Peoria, AZ (US)

(73) Assignee: Name That Sticks, LLC, an Arizona Limited Liability Company, Peoria, AZ (US)

(21) Appl. No.: 14/451,831

(22) Filed: Aug. 5, 2014

(51) Int. Cl. G09F 3/10; B32B 37/12; B32B 37/18; B42D 5/00

(52) U.S. Cl. CPC G09F 3/10; B42D 5/003; B32B 37/12; B32B 37/18; G09F 2003/0202

(57) ABSTRACT

A social media device, and a method of applying a social expression message to an object are provided, that enables a poster to prepare, customize and leave a social expression message on virtually any form of object on which the poster would want to leave such a message. The invention enables the poster to customize the message, in a way that personalizes the message for the recipient of the message, or for any who may view the object with the poster's message thereon.

### RELATED APPLICATION/CLAIM OF PRIORITY

This application is related to and claims priority from US provisional application Ser. No. 61/862783, filed Aug. 6, 2013, which provisional application is incorporated by reference herein.

### BACKGROUND AND SUMMARY OF THE PRESENT INVENTION

There are times when a person is viewing an object such as a photograph, a painting, a sculpture, an automobile, a coffee mug, a document, or any other object that may catch the person's attention, where the person desires to make a comment and express the person's fondness of the object. The person may not just want to speak to the owner of the object, but may prefer to express their fondness for the object in a writing or other form of social expression media.

The present invention provides a new and useful social media device, and to a method of providing a personal social expression message to an object.

With the present invention, a poster (i.e. the person or persons who wants to make the social expression message or someone on behalf of that person or persons), can use the device and the method of the present invention to express the poster's fondness, or other feelings about, an object.

The social media device comprises a new and useful note, which may be a part of a note pad with a plurality of the notes, each of which can be peeled from the note pad and adhered to an object (e.g. by means of an adhesive on the back side of the note). Each note has a front side with an image of the poster (i.e. the person posting the note) or any image the poster desires (such as a car, pet, family photo, etc.) and a social expression message of the poster thereon (which can be preprinted or customized, or both), so that a poster can peel off a note from the note pad, and adhere the note to any object upon which the poster wants to leave the social expression message.

In a particularly preferred version of the device, the front side of each note has an image of a pointer, which allows the poster to orient the note with the pointer pointing at a portion of the object selected by the poster. In addition, the front side of each note may have a writing space in which the poster can write a part of the social expression message.

In practicing the method of the invention, a poster (i.e. the person(s) posting the note, or someone posting the note on behalf of the poster), takes an individual note (e.g. peels a note from a note pad), and applies the note to an object to leave the social expression message from the poster on the object. Since the front side of each note has an image of the poster, the person viewing the note knows immediately who posted it, and where the note has a pointer, the step of applying the note to the object comprises orienting the note with the pointer pointing at a portion of the object selected by the poster, so that the person viewing the note knows what portion of the object to which the note is referring. In addition, the writing space enables the poster to add a personal comment that can be viewed by a person viewing the note.

Further features of the present invention will be apparent from the following detailed description and the accompanying drawings

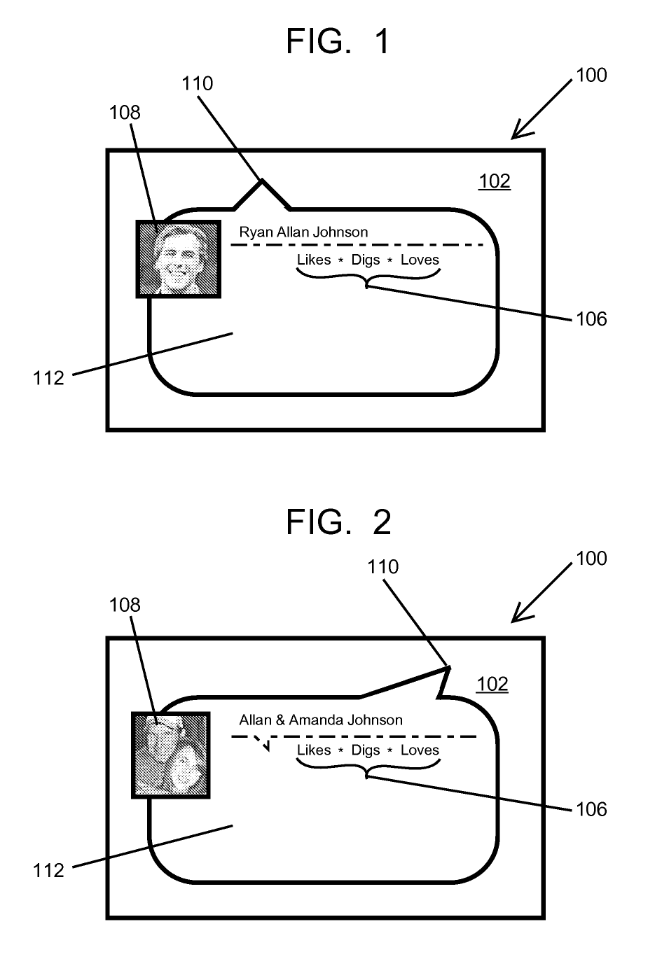

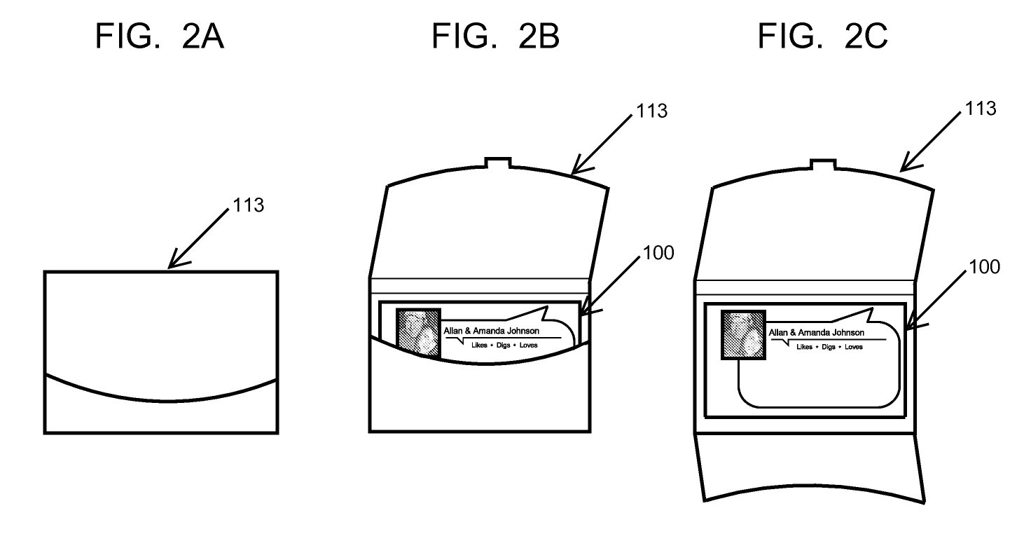

FIGS. 1 and 2 are examples of a social media device, according to the present invention;

FIGS. 2A, 2B and 2C show an example of a holder for a social media device, or a plurality of social media devices, in accordance with the present invention;

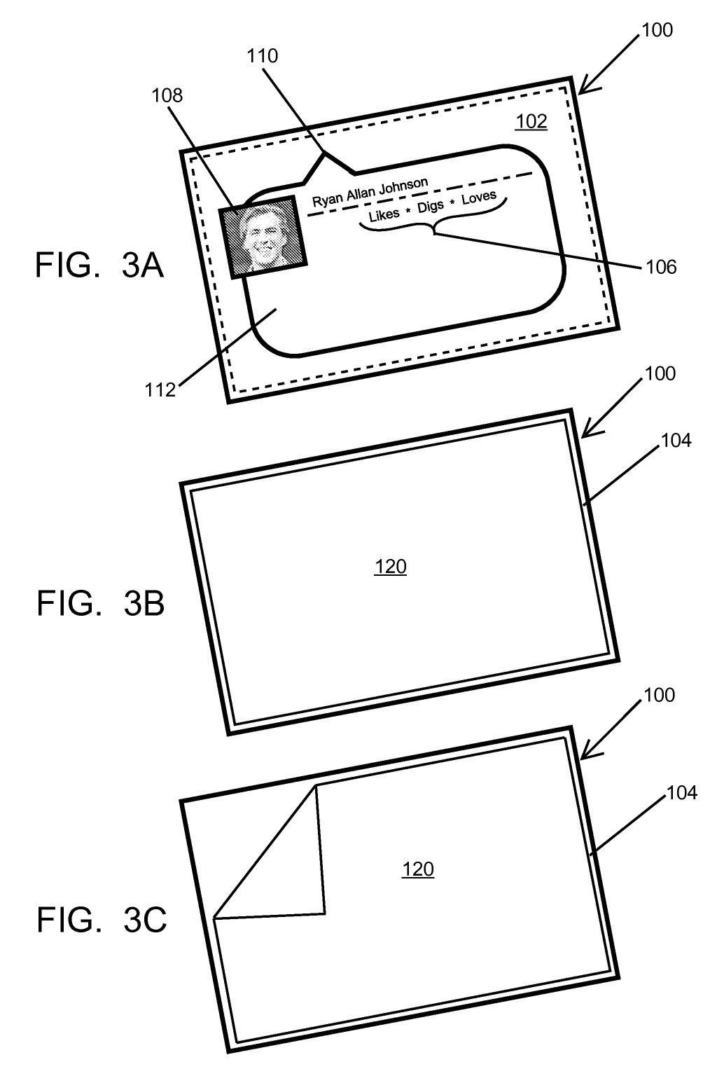

FIGS. 3A, 3B and 3C show an example of the front and back sides of one form of social media device, in accordance with the present invention;

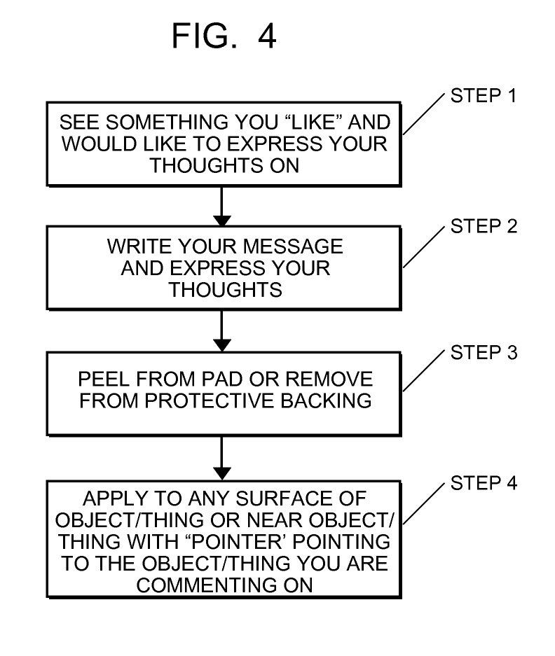

FIG. 4 schematically illustrates the applicant's method for practicing the present invention;

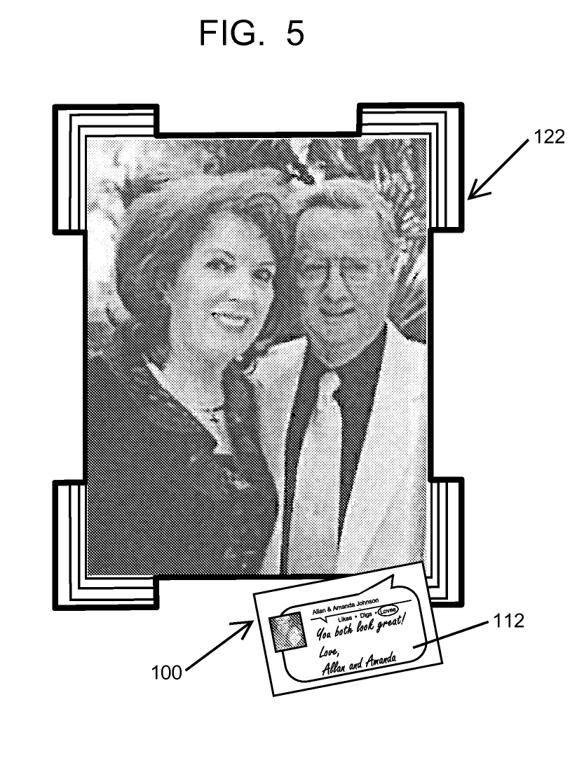

FIG. 5 shows a social expression device applied to an object, according to the present invention; and

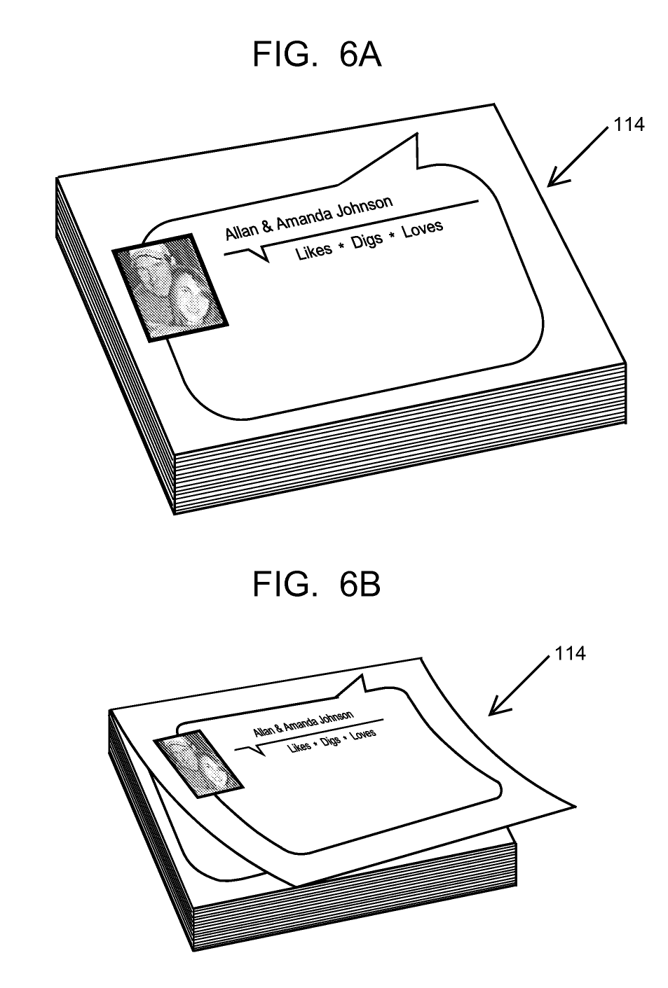

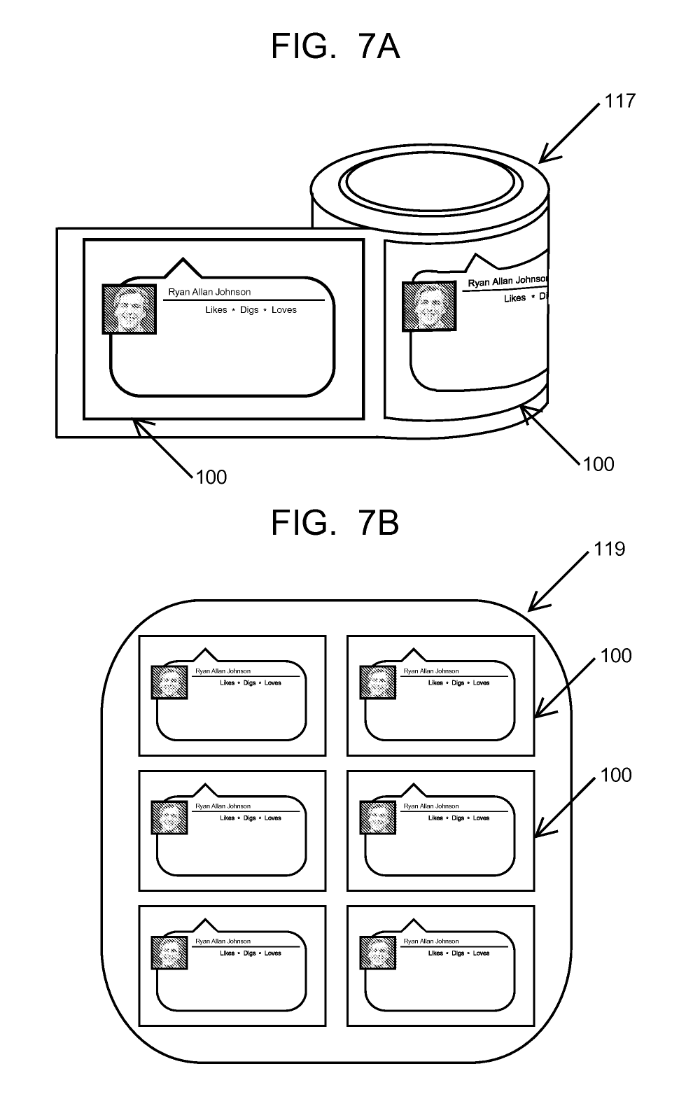

FIGS. 6A, 6B and 7A, 7B schematically illustrate the manner in which social expression notes can be formed as a pad, in accordance with the present invention.

### DETAILED DESCRIPTION

As described above, the present invention provides a new and useful social media device, and to a method of providing a social expression message to an object. The principles of the present invention are described and shown herein in connection an object such as a painting or photograph, and from that description the manner in which the present invention can be practiced with virtually any object for which a poster wants to leave a social expression message will be apparent to those in the art.

FIGS. 1 and 2, and FIGS. 3A-C are examples of a social media device 100, according to the present invention. The social media device 100 comprises a note with a front side 102 on which an image of a poster is provided, and a back side 104 (FIGS. 3B, C) that has an adhesive for adhering the note to an object upon which the poster wants to leave a social expression message. As shown by those figures, the image on the front side 102 can take any form the poster prefers, and the front side 102 of the note can also have some preprinted forms of social expression messages 106 (e.g. “likes”, “digs” “loves”) that the poster may want to highlight. Also, as shown in FIGS. 1, 2 and 3A, the front side 102 may have a drawing or photo 108 that visually associates the poster with those preprinted forms of social expression messages, so it appears that the poster is speaking the message.

As also seen in FIGS. 1, 2 and 3A, the front side 102 has an image of a pointer 110 (in FIGS. 1 and 3A the pointer 110 points upward and in FIG. 2 the pointer 110 points to the upper right side of the note). As also seen from FIGS. 1, 2, and 3A, the front side 102 of the note and also includes a writing space 112. The image of the pointer 110 can be a printed image, a die cut outline of a pointer, or any other form of image that provides the front side with a visual image of the pointer 110. The writing space 112 enables a poster to customize the social expression message of the note (see e.g. FIG. 5, described further below). The pointer 110 is designed so that when the note is applied to an object, the pointer is directed at a portion of the object to which the poster wants to call attention (see e.g. FIG. 5 described further below.)

The notes 100 can be carried around in the form of pads of the notes, or in customized packages (shown schematically at 113 in FIGS. 2A, 2B and 2C). “In this application, the concept of a plurality of notes being provided as part of a “pad” from which a single note can be removed and used to apply a social expression message to an article can take a variety of forms. For example, the “pad” can be similar to a pad of Post It® or sticky note™ brand notes, which are pads of adhesive-backed paper notes from which single notes with adhesive on their back sides can be conveniently peeled and then adhered to an object to provide a social expression message (that type of “pad is schematically shown at 114 in FIGS. 6A and 6B). The “pad” could also be a substrate or roll of the type that can support a plurality of stickers, which each “sticker” would be a social expression note 100 that can be peeled from the substrate or roll or sheet and used to apply a social expression message to an object (the notes could have adhesive on their back sides that enables them to adhere to the substrate or roll, allow single notes to be peeled from the substrate and the adhesive on the back side of a peeled off note used to adhere the note to an object. Those types of pads are schematically shown in FIGS. 7A (which shows a roll 117 with the notes 100) and 7B (which shows a substrate 119 with the notes 1). The “pad” could also be a collection of notes which are bound together in some fashion (e.g. by a fastener or chord that extends through holes formed in the notes) and individual notes can be removed from the collection in order to apply a social expression message to an article. In that case, each individual note would have an adhesive on its back side and a peel off member that uncovers the adhesive and enables the note to be adhered to an object (as shown and described in connection with FIGS. 3A-3C).

In addition, it will also be apparent to those in the art that the texture of the note 100 could be paper like (similar to that of Post It® or sticky note™ brand notes), or it could have a texture similar to that of a peel off sticker (e.g. a plastic like material with a glossy front side and a back side with adhesive with a covering that is peeled off to enable the note to be adhered to an object), or a film-like material that can adhere to surfaces such as glass, plastic, or other materials by its interaction with those materials Thus, in this application reference to a note having an “adhesive” on its back side means that the back side of the note has a chemical adhesive or its back side has a film like material that can interact with the material of the object, either of which enables the note to adhere to an object (although a film like material may be limited in terms of its ability to adhere to an object formed of a material other than glass, plastic or other materials that can interact with the film like material)

As also shown in FIGS. 2A-2C, the notes 100, or note pads can be carried in customized packages 113, that make it simple and efficient for a poster to carry the notes or the note pads around, and customize and post a note at the poster's discretion. These customized packages may include a pen, pencil, or other writing device.

Thus, besides the notes being parts of pads, it should also be noted that the notes 100 can be in the form of individual notes with peel and stick decals (sticker style) that enable an individual note to have the adhesive exposed by peeling the decal from the back of the note, and then adhering the note to an object of interest. That concept is shown in FIGS. 3A-3C, where each note 100 has a back side 104 that has adhesive and a peel off cover 120 on top of the adhesive. The cover 120 can be peeled from the back side 104 of the note, to uncover the adhesive and enables the note 100 to be selectively adhered to an object to which the poster wants to apply a social expression message.

FIG. 5 illustrates one type of object(e.g. a painting or photograph 122) to which a note 100 can be prepared, customized, applied to an object, and received and viewed by the proprietor of the object. FIG. 5 shows a note 100 that has been customized with a social expression message in the writing space 112 before the note 100 is applied to the object 122. FIG. 5 also shows how the customized note can be applied to the object at the discretion of the poster and in an orientation selected by the poster. Once the note has been applied to the object, the note may be received and viewed by the proprietor of the object or others.

FIG. 4 schematically illustrates the applicant's method for practicing the present invention. As shown in FIG. 4 a poster may see an object on which the poster would like to express a thought, in writing (Step 1). The poster would either select one of the social expression messages on the top note in the pad, write a customized message (Step 2), or both on the note the poster would like to leave on the object. The poster would then peel the note from the pad (Step 3), or remove any protective backing on the back side of the note, so that the adhesive on the note is fully effective. The poster would then apply the note to the object with the pointer oriented to point to any part of the object upon which the poster wants to comment (Step 4). As will be apparent from the foregoing description, and the attached figures, the present invention enables a poster to prepare, customize and leave a social expression message on virtually any form of object on which the poster would want to leave such a message. The invention enables the poster to customize the message, in a way that personalizes the message for the recipient of the message, or for any who may view the object with the poster's message thereon.

With the principles of the invention in mind, the manner in which those principles can be applied to enable a poster to create, customize and apply a social expression message to virtually any object will be apparent to those in the art.

1. A social media device comprising a note pad with a plurality of preformed notes, each of which has a front side and a back side and each of which can be peeled from the note pad by a poster wanting to leave a social expression message related to an object and adhered to or near the object by means of an adhesive on the back side of the note, the front side of each preformed note having either or both of an image of the poster and a social expression message of the poster thereon, so that a poster can peel off a note from the note pad, and adhere the note to or near an object to which the poster wants to leave the social expression message.

2. The social media device of claim 1, wherein the front side of each preformed note has an image of a pointer, that points away from the social expression message and allows the poster to orient the note with the pointer pointing at an object or a portion thereof selected by the poster.

3. The social media device of claim 2, wherein the front side of each preformed note has a writing space in which the poster can write a part of the social expression message.

4. A method of providing a social expression message to an object, comprising
a. providing a note pad with a plurality of preformed notes, each of which has a front side and a back side and each of which can be peeled from the note pad by a poster wanting to leave a social expression message related to the object, and adhered to or near the object by means of an adhesive on the back side of the note, the front side of each preformed note having an image of the poster and a social expression message from the poster thereon, and
b. peeling a preformed note from the note pad, and applying the note to or near an object to leave the social expression message from the poster on or near the object.

5. The method of claim 4, wherein the front side of each preformed note has an image of a pointer that points away from the social expression message, and the step of applying the note to the object comprises orienting the note with the pointer pointing at the object or a portion of the object selected by the poster.

6. The method of claim 5, wherein the front side of each preformed note has a writing space in which the poster can write a part of the social expression message.

7. A method of providing a social expression message to an object, comprising
a. providing a preformed note having a front side and a back side and configured to be adhered to or near an object by a poster wanting to leave a social expression message related to the object by means of an adhesive on the back side of the note, the note having a front side with an image of the poster- and a social expression message from the poster thereon, and
b. adhering the note to or near an object by the poster to leave a social expression message from the poster on the object.

8. The method of claim 7, wherein the front side of the preformed note has an image of a pointer that points away from the social expression message, and the step of applying the note to the object comprises orienting the note with the pointer pointing at or near a portion of the object selected by the poster.

9. The method of claim 8, wherein the front side of each preformed note has a writing space in which the poster can write a part of the social expression message.
